(19) United States
(12) Patent Application Publication
(10) Pub. No.: US 2012/0131868 A1
(43) Pub. Date: May 31, 2012

(54) ALTERNATIVE LOCKING DEVICE

(76) Inventor: Michael John Miller, Vilamoura (PT)

(21) Appl. No.: 12/981,820

(22) Filed: Dec. 30, 2010

(30) Foreign Application Priority Data
Nov. 25, 2010 (GB) GB1020006.1

(51) Int. Cl. E06B 1/04; F16B 17/00

(52) U.S. Cl. 52/204.1; 403/345; 403/376

(57) ABSTRACT

The locking device includes two plates, one plate being fixable to a frame of a window or a door and the other plate being removably enagageable with the first plate. Each plate is provided with at least one aperture and one projection, the aperture of each plate being positioned such that it can receive the projection of the other plate when the plates are brought into engagement with one another. The two plates may be held in engagement using any suitable, removable locking means.

This invention relates to a locking device. The locking device is suitable for use in securing door and window frames in a closed position.

In recent times increased security has become important to homeowners to prevent unwanted entrants into their homes. As part of this increased security locking devices are often fitted to doors, including patio doors, and windows to make opening them from the outside more difficult.

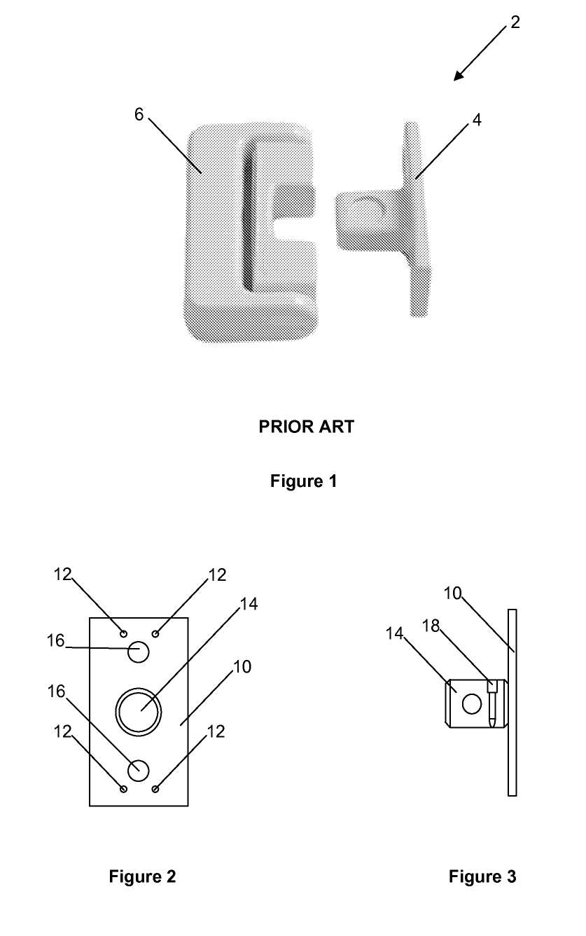

One known locking device is the use of a key operated lock within a window or door's closing mechanism, such as a handle. A user may then use a key to lock the handle and prevent its rotation. Another known locking device 2 is illustrated in FIG. 1 and has a staple portion 4 attached to the outer, stationary part of the window or door frame and a hingeable portion 6 attached to the moveable part of the window or door frame. The hingeable portion 6 is positioned to be able to pass over the staple portion 4 when the window is closed and a key can then be used to extend a grub screw, or similar, (not shown) into contact with the staple portion 4. Further extension of the grub screw pulls the moveable part of the window or door frame towards the stationary part of the window or door frame, thereby decreasing the opportunity for a person to slip something between the two parts of the frame to force entry.

Whilst these locking mechanisms improve the security of a door or window they also require the use of a key. Keys can become lost meaning that the door or window cannot be adequately secured, either permanently or temporarily. Key operated window locks can also be difficult for people with agility problems and limited hand function to use.

According to a first aspect of the invention there is provided a locking device including a first plate comprising a projection and an aperture, a second plate comprising a projection and an aperture, releasable means for securing the first and second plate in engagement with one another wherein the projection of the first plate is arranged to pass through the aperture of the second plate and the projection of the second plate is arranged to pass through the aperture of the first plate when the first and second plates are brought into engagement. By using a plate as a removable feature the locking device may be more readily used by people with motor problems. Additionally, the use of the projections and apertures means that the locking device cannot be rotated using outside means to move the locking device into a less secure conformation.

Optionally, the first plate may comprises a second aperture and the second plate a second projection, the second projection being arranged to pass through the second aperture when the first and second plates are brought into engagement. This provides further security against rotational interference with the locking device.

The means for securing the first and second plate in engagement comprises the projection of the first plate being provided with a channel for passing a padlock or chain through. The ability to use a padlock or other lockable means to secure the locking device means that, if the property is to be left locked for any long period of time additional security is provided.

Alternatively, the means for securing the first and second plate in engagement may be a spring clip attachable to the projection of the first plate. The spring clip is able to be held in engagement around a substantial part of the circumference of the lockable projection. The spring clip may be made from any suitable material, however, it should enable sufficient frictional engagement to prevent easy sliding along the length of the projection of the first plate.

The projection of the first plate may be provided with a recessed portion around at least part of its circumference, the recessed portion being configured to receive a spring clip and form a channel in which it can sit. Alternatively, the projection of the first plate may be provided with horizontal ribs. The presence of the recessed portion and ribs increases any external force that is required to push the spring clip along the length of the locking projection.

The releasable means may, alternatively, comprise one or more pins configured to retract into and project from the projection of the first plate, such that, when the one or more pins are projecting from the projection they hold the second plate in engagement with the first plate. The one or more pins may comprise spring release pins configured to be biased towards projecting from the projection or be moveable between a position where they project from the projection of the first plate and are retracted into the projection of the first plate by rotating at least a part of the first projection.

The first plate is preferably provided with means for attaching the plate to a door or window frame.

According to another aspect of the present invention there is provided a doorframe or a window frame including the first plate. The doorframe or window frame are preferably provided with one or more means, in registration with the apertures of the first plate, arranged to receive the projection of the second plate. This allows the projections of the first plate to be of greater length and increases the engagement of the locking device with the window frame thereby increasing security.

A specific embodiment of the present invention will now be described by reference to the following drawings in which:

FIG. 1 illustrates a prior art locking device;

FIG. 2 is a bird's eye view of a plate of the present invention;

FIG. 3 is a side on view of a plate of the present invention;

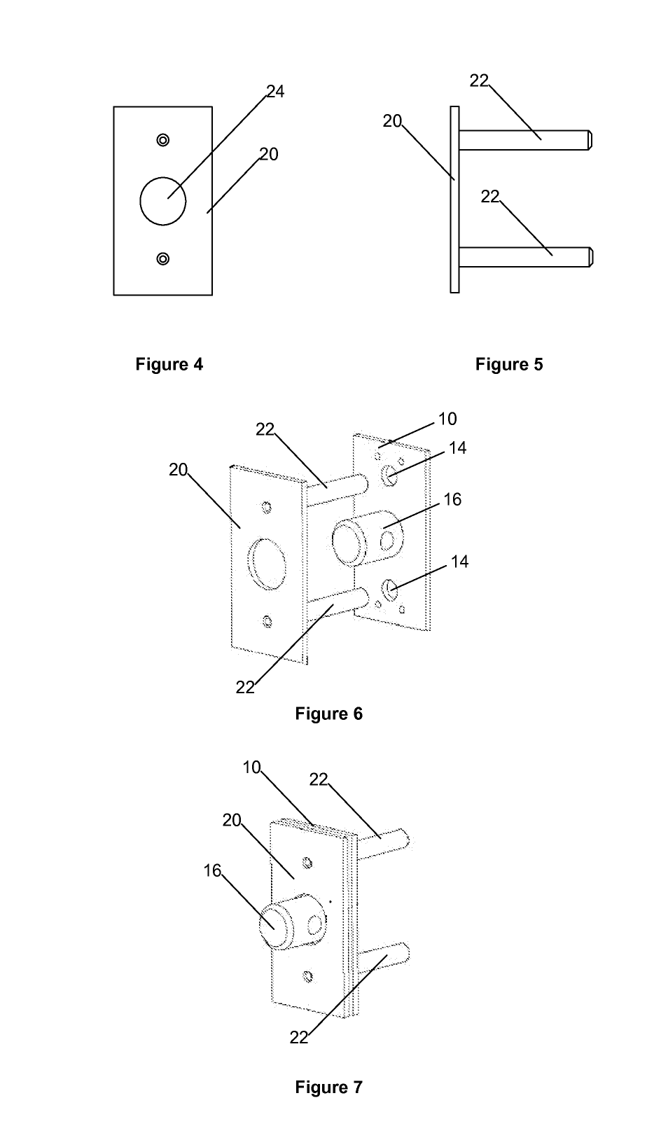

FIG. 4 is a bird's eye view of a removable plate of the present invention;

FIG. 5 is a side on view of a removable plate of the present invention;

FIG. 6 illustrates the plates being brought into engagement with one another;

FIG. 7 illustrates the plates in engagement with one another; and

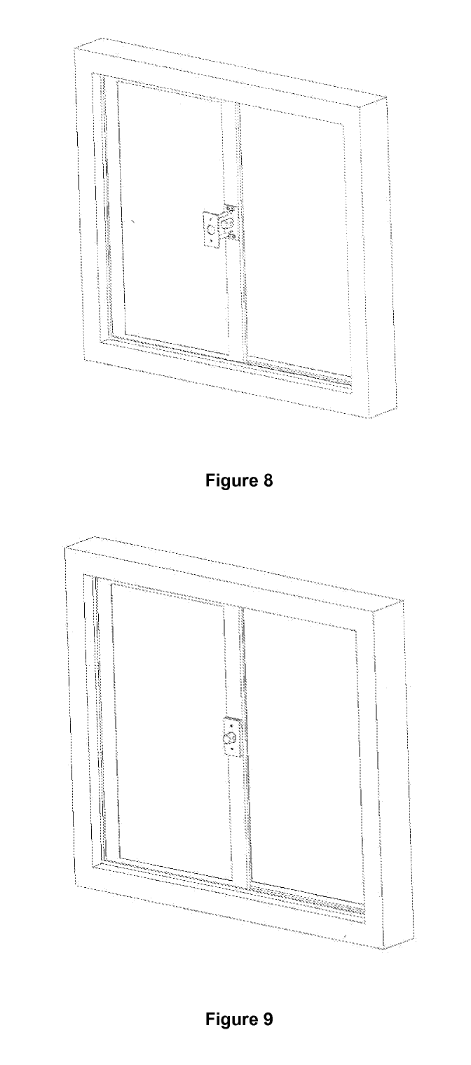

FIGS. 8 and 9 illustrate the locking device in use on a window frame.

FIGS. 2 and 3 illustrate a fixable plate 10 of the present invention. The plate 10 includes four screw holes 14, each screw hole 14 being sized to enable a screw to pass through it; the screws being used to fasten the plate 10 to a window or door frame as illustrated in FIG. 8. The plate 10 includes two further apertures 14 and a locking projection 16 which will be described in more detail below.

FIGS. 4 and 5 illustrate a removable plate 20 of the present invention. The removable plate 20 comprises two projections 22 and an aperture 24. The aperture 24 is positioned to allow the locking projection to pass through it when the projections are projecting through the apertures in the fixing plate as illustrated in FIGS. 6 and 7.

Preferably, the projections 22 of the removable plate 20 pass through the apertures 14 in the plate 10 and are received within the frame of the window or door as illustrated in FIGS. 8 and 9. By receiving these projections within the frame rotation of the plates using an external force can be prevented.

The locking projection on the fixing plate is provided with a means to prevent the locking plate from sliding free and enabling the window to become unlocked.

The means to prevent the locking plate from sliding free may be a grub screw 17 as illustrated in FIG. 3. The grub screw may be screwed into the locking projection 16 in order to allow the removable plate to pass over the site of the screw and be either brought into engagement with, or apart from, the plate. When the two plates are in engagement with one another the grub screw 17 may be screwed out so that it partially extends out of the locking projection and prevents the removeable plate from passing over it and becoming unengaged with the other plate.

Optionally, the locking projection may be provided with, either in addition to or in combination with the grub screw 17, a channel 18 through which a padlock, cable tie or other fixable member can be passed. The presence of the padlock means that the removable plate cannot be brought out of engagement with the plate and thereby increases the security of the window further.

Alternatively, a spring clip may be fastened around the projection adjacent to the removable plate to hold the plates in contact. This increases the force required to disengage the removable plate from the plate fixed to the frame. A groove, not shown, may also be provided in the locking projection. The groove is configured to receive the spring clip and thereby ensure that the spring clip is situated in the correct position. The advantage of using a spring clip to fasten the plates in engagement is that it is easily locatable. The spring clip may be attached via a tether, such as a chain to either the locking plate or the fixing plate.

Optionally, the locking projection may be provided with one or more retractable pins which are retractable into the locking projection to allow the removable plate to pass over the pins. Each retractable pin is preferably situated such that, when the locking projection is in contact with the fixing plate the retractable pin is in contact with the locking plate and thereby holding the plates in contact.

The retractable projection may, for example be controlled by a biasing means such as a spring or any other suitable means. Alternatively, the retractable pins may be manually controlled, for example, they may be retracted and projected from the locking projection by rotating a part of the locking projection.

The length of the projections from the locking plate are preferably less than the depth of the frame to which the locking device is to be applied.

As will be understood by the skilled person the plate may be affixed to the frame using any suitable means, for example, it may be fixed using nails, or adhesive glue. Additionally, the locking device may be attached in any suitable position that enables the frame to be maintained in a closed position. For example, it may be provided across a join in two moveable parts of a frame, with one removable plate projection entering one moveable part and the other removable plate projection entering another part.

1. A locking device comprising:
(i) a first plate comprising a projection and an aperture;
(ii) a second plate comprising a projection and an aperture; and
(iii) releasable means for securing the first and second plate in engagement with one another;
wherein the projection of the first plate is arranged to pass through the aperture of the second plate and the projection of the second plate is arranged to pass through the aperture of the first plate when the first and second plates are brought into engagement.

2. The locking device of claim 1, wherein:
the first plate comprises a second aperture and the second plate comprises a second projection, the second projection being arranged to pass through the second aperture when the first and second plates are brought into engagement.

3. The locking device of claim 1, wherein:
the means for securing the first and second plate in engagement comprises the projection of the first plate being provided with a channel for passing a padlock or chain through.

4. The locking device of claim 1, wherein:
the means for securing the first and second plate in engagement comprises a spring clip attachable to the projection of the first plate.

5. The locking device of claim 4, wherein:
the projection of the first plate is provided with a recessed portion around at least part of its circumference, the recessed portion being configured to receive a spring clip.

6. The locking device of claim 1, wherein:
the releasable means comprises at least one pin configured to retract into and project from the projection of the first plate, such that, when said at least one pin projects from the projection it holds the second plate in engagement with the first plate.

7. The locking device of claim 6, wherein:
said at least one pin comprises a spring release pin configured to be biased towards projecting from the projection.

8. The locking device of claim 6, wherein:
at least one pin is moved between a position where it projects from the projection of the first plate and is retracted into the projection of the first plate by rotating at least a part of the first projection.

9. The locking device of claim 1, wherein:
the first plate is provided with means for attaching the plate to a frame.

10. A doorframe comprising:
(i) a first plate comprising a projection and an aperture;
(ii) a second plate comprising a projection and an aperture; and
(iii) releasable means for securing the first and second plate in engagement with one another;
wherein the projection of the first plate is arranged to pass through the aperture of the second plate and the projection of the second plate is arranged to pass through the aperture of the first plate when the first and second plates are brought into engagement.

11. The doorframe of claim 8, wherein:
the doorframe is provided with one or more means, in registration with the apertures of the first plate, arranged to receive the projection of the second plate.

12. A window frame comprising:
(i) a first plate comprising a projection and an aperture;
(ii) a second plate comprising a projection and an aperture; and
(iii) releasable means for securing the first and second plate in engagement with one another;
wherein the projection of the first plate is arranged to pass through the aperture of the second plate and the projection of the second plate is arranged to pass through the aperture of the first plate when the first and second plates are brought into engagement.

13. The window frame of claim 10, wherein:
the doorframe is provided with means, in registration with the apertures of the first plate, arranged to receive the projection of the second plate.

14.-16. (canceled)
